(19) United States
(12) Patent Application Publication
(10) Pub. No.: US 2009/0200718 A1
(43) Pub. Date: Aug. 13, 2009

(54) Spring Shock Absorber for a Motor Vehicle

(75) Inventors: Matthias Roemer, Holzgerlingen (DE); Ralf Wilhelm, Oberreichenbach (DE)

Correspondence Address: CROWELL & MORING LLP;INTELLECTUAL PROPERTY GROUP, P.O. BOX 14300, WASHINGTON, DC, 20044-4300, US

(73) Assignee: DAIMIER AG, STUTTGART (DE)

(21) Appl. No.: 12/298,890

(22) PCT Filed: Apr. 27, 2007
(86) PCT No.: PCT/EP07/03734

§ 371 Date: Feb. 27, 2009

(30) Foreign Application Priority Data
Apr. 29, 2006 (DE) 10-2006-019.7
Aug. 17, 2006 (DE) 10-2006-038-523.3

(51) Int. Cl. B60G 11/27

(52) U.S. Cl. 267/123

(57) ABSTRACT

In a spring shock absorber for a motor vehicle, with a first body part and a second body part, the first body part forms a first changeable volume with the second body part by way of a first rolling bellows, and the second body part forms a second changeable volume with a roll-off piston connected to the first body part by way of a second rolling bellows. The two rolling bellows are arranged in such a way that they are guided in the radial direction during a rolling motion by lateral contours of the two body parts and the roll-off piston. The two volumes are connected to one another via a throttle element and form a hermetically closed two-volume system with respect to a deflection of the spring shock absorber. The roll-off piston is guided through the second body part in a longitudinally displaceable manner by means of a sealing element.

### BACKGROUND AND SUMMARY OF THE INVENTION

This invention relates to a spring shock absorber, and in particular to an air spring shock absorber for a motor vehicle, with a first body part and a second body part, the first body part forming a first changeable volume with the second body part by way of a first rolling bellows, and the second body part forming a second changeable volume with a roll-off piston connected to the first body part by way of a second rolling bellows. The two rolling bellows are arranged in such a way that they are guided in the radial direction during a rolling motion by lateral contours of the two body parts and the roll-off piston. The two volumes are connected to one another by a throttle element and form a hermetically closed two-volume system with respect to a deflection of the spring shock absorber.

A spring shock absorber of this type for a motor vehicle is disclosed by European document EP 1 344 957 B1. This shock absorber includes two hermetically closed air springs filled with compressed air. Each of the air springs has a changeable volume, and the changeable volumes are connected by a throttle element, which can be traversed in two flow directions.

The first air spring has a first downwardly-open, bell-shaped body, which is connected to a second downwardly-open, bell-shaped body by way of a first rolling bellows. In addition, a roll-off piston projects into the lower opening of the second bell-shaped body and forms the second air spring with the second bell-shaped body by way of a second rolling bellows. The rolling bellows are arranged in such a way that they are guided in the radial direction during a rolling motion by way of lateral contours of the two bell-shaped bodies and the roll-off piston. In this case the roll-off piston is connected to the first bell-shaped body by an L-shaped connecting element, which is disposed outside the spring damper.

A disadvantage of this known spring shock absorber is that the L-shaped connecting element takes up additional space on the outside of the spring shock absorber, and use of the known spring shock absorber in confined body environments can therefore give rise to problems. At the same time, because the second body is open towards the road surface, sealing against undesired contamination is made more difficult.

It is therefore the object of the present invention to provide a spring shock absorber for a motor vehicle that has a compact construction and reliable sealing against undesired contamination.

This object is achieved by a spring shock absorber as claimed.

The spring shock absorber of this invention has a first body part and a second body part, the first body part forming a first changeable volume with the second body part by way of a first rolling bellows, and the second body part forming a second changeable volume with a roll-off piston connected to the first body part by way of a second rolling bellows. The two rolling bellows are arranged in such a way that they are guided in the radial direction during a rolling motion by lateral contours of the two body parts and of the roll-off piston. The two volumes are connected to one another by a throttle element and form a hermetically closed two-volume system with respect to a deflection of the spring shock absorber.

The spring shock absorber according to the invention comprises exactly two volumes and a differential rolling bellows formed by the two associated rolling bellows. Such an arrangement provides an especially good shock-absorbing effect combined with a high load capacity.

According to the invention, the roll-off piston is guided through the second body part in a longitudinally displaceable manner by a sealing element. Because the roll-off piston runs inside the spring shock absorber, it is possible to create a constructionally compact spring shock absorber that is closed on all sides. The closed construction ensures reliable sealing against undesired contamination.

The spring shock absorber is operated, for example, by pressure medium from a pressure medium supply present in a motor vehicle, and typically by compressed air from a compressed air accumulator or the like.

Advantageous configurations of the spring shock absorber according to the invention are claimed.

The throttle element is advantageously arranged outside the spring shock absorber, so that the thermal load capacity of the spring shock absorber can be increased through the improved heat exchange with the environment. This is important, above all, when driving on poor road surfaces.

If no excessive demands are placed on the thermal load capacity of the spring shock absorber, it is possible for the throttle element to be a component of the roll-off piston. The throttle element is then arranged inside the spring shock absorber. In this case, the roll-off piston has a through-passage connecting the first and second volumes, on the inlet or outlet opening of which through-passage the throttle element is located.

The flow resistance of the throttle element may be electrically adjustable by an associated valve unit, so that active adaptation of the damping force characteristic curve of the spring shock absorber to different driving conditions or road characteristics is possible. For this purpose, the spring shock absorber is a component of an active chassis incorporated in the motor vehicle.

Should the motor vehicle not have an active chassis, the throttle element may alternatively be a passive throttle element without the possibility of electrical adjustment.

In order to make a lateral movement of the roll-off piston as a result of driving conditions possible, without detriment to the sealing effect of the sealing element, it is advantageous to mount the sealing element in a radially displaceable manner in a bush arranged on the second body part. The sealing element may consist, for example, of polytetrafluoroethylene (PTFE or TEFLON) or a similar temperature-resistant material with a low coefficient of friction.

A stop buffer for limiting the deflection of the spring shock absorber is advantageously arranged inside the first and/or second volumes/volume. In this case, the stop buffer serves at the same time as a volume-canceling element, which, through suitable specification of its volume and of its compressibility, permits specified influencing of the spring force characteristic curve and/or the damping characteristic curve of the spring shock absorber.

A high operating pressure is a precondition for a satisfactory damping effect of the spring shock absorber. Through appropriate selection of the difference between the (effective pressurized) radii of the two rolling bellows or of the differential rolling bellows formed thereby, the load capacity of the spring shock absorber can be adapted as desired in relation to the prevailing operating pressure.

In order to increase the bending stiffness of the spring shock absorber, the first and second rolling bellows are preferably mounted in a radial gap formed by the first and second body parts and the roll-off piston. It is advantageous to provide a distance that is as large as possible between the two rolling bellows in order to compensate sufficiently high bending moments.

Additionally or alternatively, it is possible for the roll-off piston to be supported with respect to the second body part by one or more sliding bearings, with the effect that a bending moment occurring between the first and second body parts can be limited to non-critical values.

The two body parts and the roll-off piston advantageously cooperate with the first and second rolling bellows in such a manner that, upon deflection of the spring shock absorber, one of the two volumes is reduced while the other volume is increased. Through the reciprocal change of volume, comparatively high flow velocities occur in the throttle element or in the throttle gap even at small shock-absorber amplitudes. In this way, a sufficient damping effect is ensured even at small deflections of the spring shock absorber.

Furthermore, in order to reduce bending moments acting on the spring shock absorber in the installed state, the possibility exists to connect the first body part to the body of the motor vehicle by a flexible upper bearing. The upper bearing may be in the form, for example, of an elastomer bearing or a ball joint. Furthermore, a cardanically soft elastomer bearing or a corresponding ball joint may be provided at the end of the spring shock absorber oriented towards the wheel carrier.

The spring shock absorber according to the invention is explained in more detail below with reference to the appended drawings, in which corresponding parts are provided with the same reference numerals.

### BRIEF DESCRIPTION OF THE DRAWINGS

FIG. 1 shows, in cross-section, a first embodiment of the inventive spring shock absorber with a throttle element arranged outside the spring shock absorber;

FIG. 2 shows, in cross-section, a second embodiment of the inventive spring shock absorber, in which the throttle element is arranged in the region of a first volume of the spring shock absorber as a component of a roll-off piston;

FIG. 3 shows, in cross-section, a third embodiment of the inventive spring shock absorber, in which the throttle element is arranged in the region of a second volume of the spring shock absorber as a component of the roll-off piston; and

FIG. 4 shows, in cross-section, a fourth embodiment of the inventive spring shock absorber, in which a plurality of sliding bearings are provided for limiting a bending moment acting on the spring shock absorber.

### DETAILED DESCRIPTION OF THE INVENTION

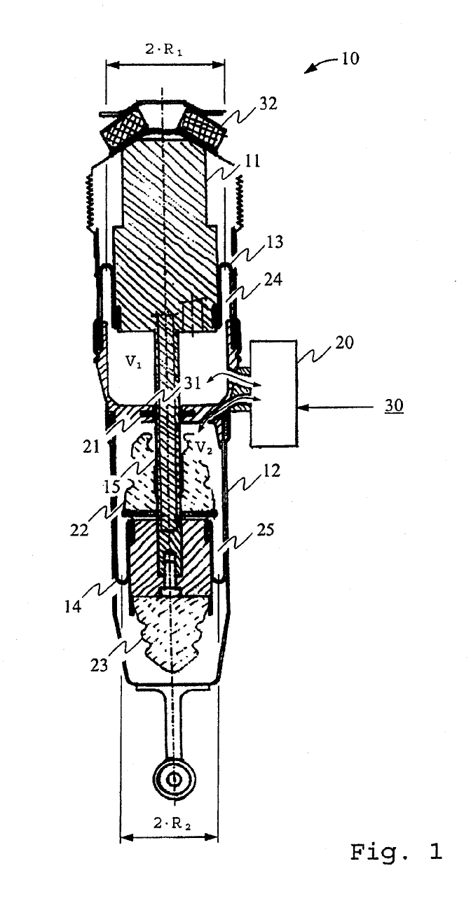

FIG. 1 shows a first embodiment of the spring shock absorber according to the invention for a motor vehicle, in which the spring shock absorber 10 is operated with pressure medium from a pressure medium supply located in the motor vehicle.

The spring shock absorber 10 has a first body part 11 and a second body part 12, the first body part 11 forming a first changeable volume V₁ with the second body part 12 by way of a first rolling bellows 13, and the second body part 12 forming a second changeable volume V₂ with a roll-off piston 15 connected to the first body part 11 by way of a second rolling bellows 14. The two rolling bellows 13 and 14 are arranged in such a way that they are guided in the radial direction during a rolling motion by lateral contours of the two body parts 11 and 12 and of the roll-off piston 15. The two volumes V₁ and V₂ are connected to one another via a throttle element 20 and form a hermetically closed, two-volume system with respect to a deflection of the spring shock absorber 10. More precisely, the two body parts 11 and 12 and the roll-off piston 15 cooperate with the first and second rolling bellows 13 and 14 in such a way that, upon deflection of the spring shock absorber 10, one of the two volumes V₁ or V₂ is reduced while the other volume V₂ or V₁ is increased. In this case, the roll-off piston 15 is guided in a longitudinally displaceable manner through the wall of the second body part 12 by a sealing element 21 separating the two volumes V₁ and V₂ from one another.

In order to limit the deflection of the spring shock absorber 10, respective first and second stop buffers 22, 23 are provided for the two possible directions of motion. As an example, the first stop buffer 22 is arranged inside the second volume V₂. Additionally or alternatively, the second stop buffer 23 is arranged in the first volume V₁.

Each of the two rolling bellows 13 and 14 has a respective radius R₁, R₂, the difference ΔR₁₂=|R₁−R₂| of the two rolling bellows 13 and 14 ultimately defining the load capacity of the spring shock absorber 10 in relation to the prevailing operating pressure. Typical values are R₁≈60 mm and R₂≈47.5 mm.

In order to increase the bending stiffness of the spring shock absorber 10, the first rolling bellows 13 is mounted in a first radial gap 24 formed by the first body part 11 and the second body part 12, and the second rolling bellows 14 is mounted in a second radial gap 25 formed by the second body part 12 and the roll-off piston 15.

In the embodiment represented in FIG. 1, the throttle element 20 is arranged outside the spring shock absorber 10, and the flow resistance through the throttle element 20 is adjustable, by way of an associated valve unit, via an electrical control line 30, as a component of an active chassis incorporated in the motor vehicle.

The sealing element 21 may be an annular sealing washer, which is mounted in a radially displaceable manner in a bush 31 arranged on the second body part 12, in order to compensate for possible lateral movements of the roll-off piston 15. The sealing element 21 itself is made of polytetrafluoroethylene (PTFE or TEFLON) or a similar temperature-resistant material with a low coefficient of friction.

The spring shock absorber 10 is arranged between a support point associated with the body of the motor vehicle and a wheel carrier. In the case of a four-wheeled motor vehicle, therefore, a total of four spring shock absorbers 10 are provided, each of which is connected to the body via a flexible upper bearing 32. The upper bearing 32 is, for example, an elastomer bearing or a ball joint. Furthermore, a cardanically soft elastomer bearing or a corresponding ball joint is provided at the end of the spring shock absorber 10 oriented towards the wheel carrier.

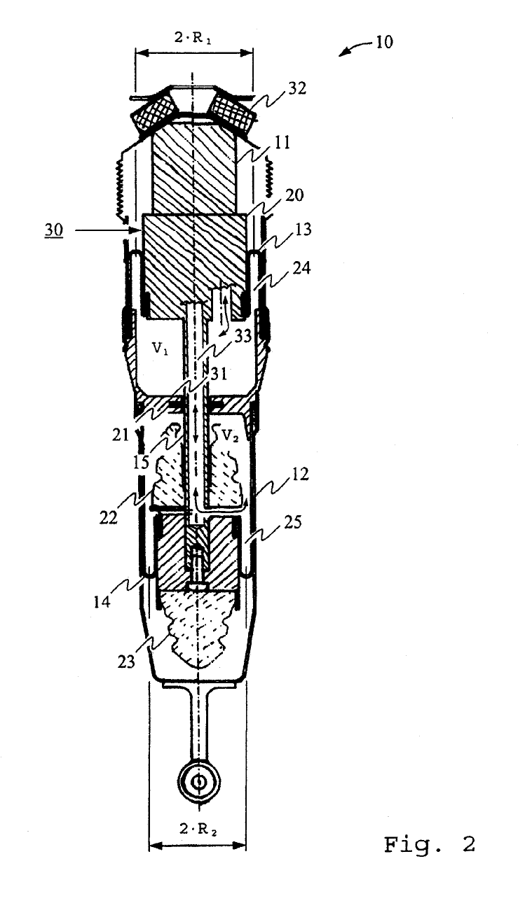

FIG. 2 shows a second embodiment of the inventive spring shock absorber for a motor vehicle, which differs from the spring shock absorber represented in FIG. 1 in that the throttle element 20 is a structural component of the roll-off piston 15. In this case, the roll-off piston 15 has a through-passage 33 which connects the first and second volumes V₁ and V₂, the throttle element 20 being located at the inlet or outlet opening of said through-passage 33 in the region of the first volume V₁.

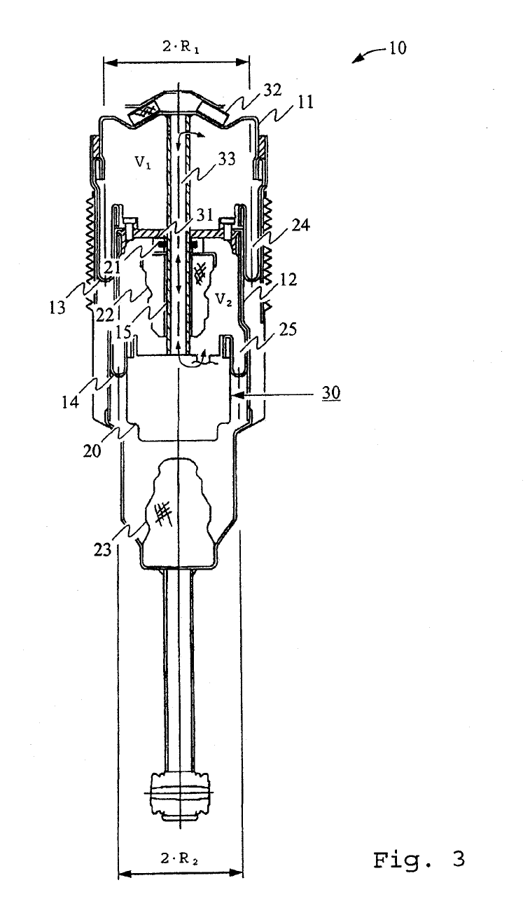

FIG. 3 shows a third embodiment of the inventive spring shock absorber. This differs from the embodiment represented in FIG. 2 only in the arrangement of the throttle element 20, which in the present case is located in the region of the second volume V₂. Because of the “nested” arrangement of the rolling bellows 13 and 14 oriented in the same direction, the spring shock absorber 10 illustrated is of especially compact construction.

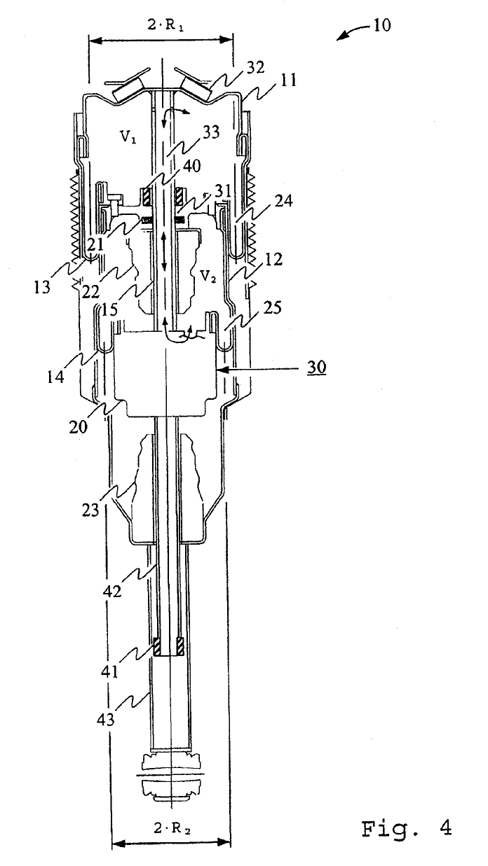

FIG. 4 shows a further embodiment of the inventive spring shock absorber, which differs from the embodiment represented in FIG. 3 in that the roll-off piston 15 is supported with respect to the second body part 12, by additional sliding bearings 40 and 41, in such a way that a bending moment acting on the spring shock absorber 10 is limited to non-critical values.

As an example, the first sliding bearing 40 is located in the region of the bush 31, whereas the second sliding bearing 41 is arranged at a distance from the first sliding bearing 40 on an extension piece 42 formed on the roll-off piston 15, which extension piece 42 is guided in a longitudinally displaceable manner by the second sliding bearing 41 inside a strut 43 connected to the second body part 12.

The play in the sliding bearings 40 and 41 in the form of sliding bushes is dimensioned such that, under normal operating conditions, in which no excessive bearing bending moment arises between the first body part 11 and the second body part 12, frictional contact between the first sliding bearing 40 and the outside of the roll-off piston 15, or between the second sliding bearing 41 and the inside of the strut 43, is excluded. That is, under normal operating conditions, the two sliding bearings 40 and 41 have no effect, and therefore have no (detrimental) influence on the response behavior of the spring shock absorber 10 under such conditions.

1-11. (canceled)

12. A spring shock absorber for a motor vehicle, comprising:
a first body part,
a second body part,
a first rolling bellows by which the first body part forms a first changeable volume with the second body part,
a roll-off piston,
a second rolling bellows by which the roll-off piston is connected to the first body part and that forms a second changeable volume with the second body part,
a throttle element by which the first and second changeable volumes are connected to one another, the changeable volumes forming a hermetically closed two-volume system with respect to a deflection of the spring shock absorber, and
a sealing element by which the roll-off piston is guided through the second body part in a longitudinally displaceable manner,
wherein the first and second rolling bellows are arranged in such a way that they are guided in the radial direction during a rolling motion by lateral contours of the first and second body parts and of the roll-off piston.

13. The spring shock absorber as claimed in claim 12, wherein the throttle element is arranged outside the spring shock absorber.

14. The spring shock absorber as claimed in claim 12, wherein the throttle element is a structural component of the roll-off piston.

15. The spring shock absorber as claimed in claim 12, wherein the flow resistance through the throttle element is electrically adjustable.

16. The spring shock absorber as claimed in claim 12, wherein the sealing element is mounted in a radially displaceable manner.

17. The spring shock absorber as claimed in claim 12, further comprising a stop buffer for limiting deflection arranged inside at least one of the first and second changeable volumes.

18. The spring shock absorber as claimed in claim 12, wherein the first and second rolling bellows are mounted in respective radial gaps formed by the first and second body parts and the roll-off piston.

19. The spring shock absorber as claimed in claim 12, wherein, upon deflection of the spring shock absorber, one of the changeable volumes is reduced while the other of the changeable volumes is increased.

20. The spring shock absorber as claimed in claim 12, further comprising a flexible upper bearing by which the first body part is connected to the body of the motor vehicle.

21. The spring shock absorber as claimed in claim 12, further comprising at least one sliding bearing by which the roll-off piston is supported with respect to the second body part.

22. A motor vehicle including a spring shock absorber as claimed in claim 12.

23. A motor vehicle including a spring shock absorber as claimed in claim 13.

24. A motor vehicle including a spring shock absorber as claimed in claim 14.

25. A motor vehicle including a spring shock absorber as claimed in claim 15.

26. A motor vehicle including a spring shock absorber as claimed in claim 16.

27. A motor vehicle including a spring shock absorber as claimed in claim 17.

28. A motor vehicle including a spring shock absorber as claimed in claim 18.

29. A motor vehicle including a spring shock absorber as claimed in claim 19.

30. A motor vehicle including a spring shock absorber as claimed in claim 20.

31. A motor vehicle including a spring shock absorber as claimed in claim 21.
